(19) United States
(12) Patent Application Publication
(10) Pub. No.: US 2007/0005883 A1
(43) Pub. Date: Jan. 4, 2007

(54) Method to keep volatile disk caches warm across reboots

(76) Inventor: Sanjeev N. Trika, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/174,068

(22) Filed: Jun. 30, 2005

(51) Int. Cl. G06F 13/00; G06F 9/00

(52) U.S. Cl. 711/113; 713/2

(57) ABSTRACT

In some embodiments, a method to keep volatile disk caches warm across reboots is presented. In this regard, a caching agent is introduced to, responsive to a system boot, load a cache data from a reserved portion of a mass storage device into a memory. Other embodiments are also disclosed and claimed.

### FIELD OF THE INVENTION

Embodiments of the present invention generally relate to the field of disk caching, and, more particularly to a method to keep volatile disk caches warm across reboots.

### BACKGROUND OF THE INVENTION

Mass storage devices, like hard drives, generally have large capacities and are a comparatively cheap way to store application and data files on non-volatile media. However, mass storage devices typically have slower access times and system performance is lowered when application and data files need to be accessed from a mass storage device as opposed to a higher speed memory device. Caching is a technique whereby a smaller faster memory stores some of the application and data files from the mass storage device that might be needed soon by a processor, thereby providing faster access to the cached files. Where volatile memory, for example dynamic random access memory (DRAM), is used as cache memory the cache data is lost when the system is shutdown. On a subsequent boot, the cache is said to be “cold,” because it is empty and needs to be filled with data.

### BRIEF DESCRIPTION OF THE DRAWINGS

The present invention is illustrated by way of example and not limitation in the figures of the accompanying drawings in which like references indicate similar elements, and in which:

FIG. 1 is a block diagram of an example electronic appliance suitable for implementing the caching agent, in accordance with one example embodiment of the invention;

FIG. 2 is a block diagram of an example caching agent architecture, in accordance with one example embodiment of the invention;

FIG. 3 is a flow chart of an example method for keeping a volatile disk cache warm across reboots, in accordance with one example embodiment of the invention; and

FIG. 4 is a block diagram of an example article of manufacture including content which, when accessed by a device, causes the device to implement one or more aspects of one or more embodiment(s) of the invention.

### DETAILED DESCRIPTION

FIG. 1 is a block diagram of an example electronic appliance suitable for implementing the caching agent, in accordance with one example embodiment of the invention. Electronic appliance 100 is intended to represent any of a wide variety of traditional and non-traditional electronic appliances, laptops, desktops, servers, disk drives, cell phones, wireless communication subscriber units, wireless communication telephony infrastructure elements, personal digital assistants, set-top boxes, or any electric appliance that would benefit from the teachings of the present invention. In accordance with the illustrated example embodiment, electronic appliance 100 may include one or more of processor(s) 102, memory controller 104, caching agent 106, system memory 108, expansion controller 110, storage device 112 and input/output device(s) 114 coupled as shown in FIG. 1. Caching agent 106, as described more fully hereinafter, may well be used in electronic appliances of greater or lesser complexity than that depicted in FIG. 1. Also, the innovative attributes of caching agent 106 as described more fully hereinafter may well be embodied in any combination of hardware and software.

Processor(s) 102 may represent any of a wide variety of control logic including, but not limited to one or more of a microprocessor, a programmable logic device (PLD), programmable logic array (PLA), application specific integrated circuit (ASIC), a microcontroller, and the like, although the present invention is not limited in this respect.

Memory controller 104 may represent any type of chipset or control logic that interfaces system memory 108 with the other components of electronic appliance 100. In one embodiment, the connection between processor(s) 102 and memory controller 104 may be referred to as a front-side bus. In another embodiment, memory controller 104 may be referred to as a north bridge.

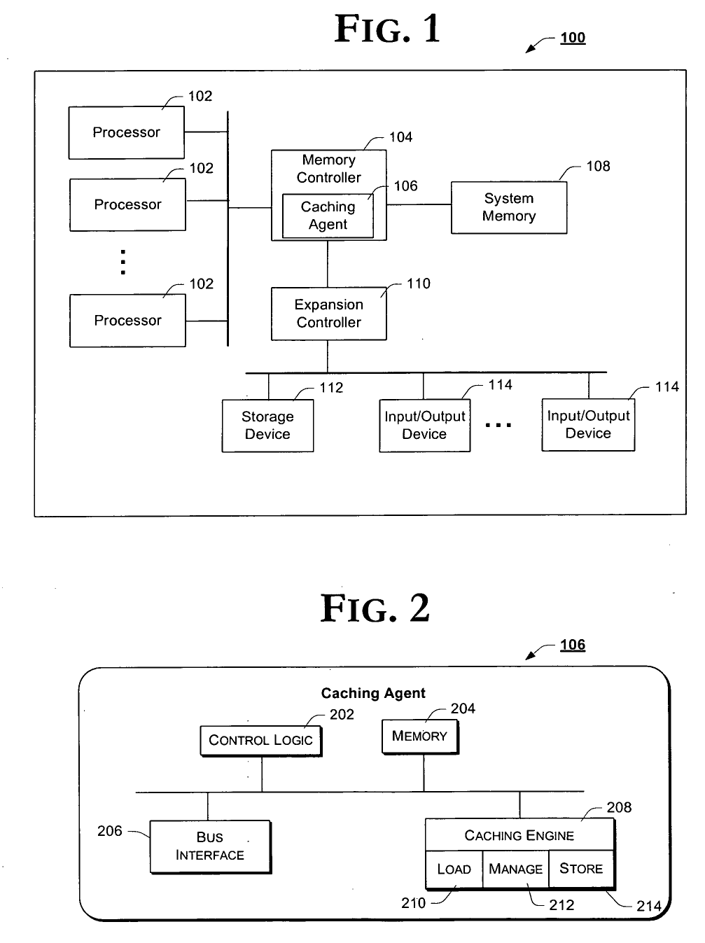

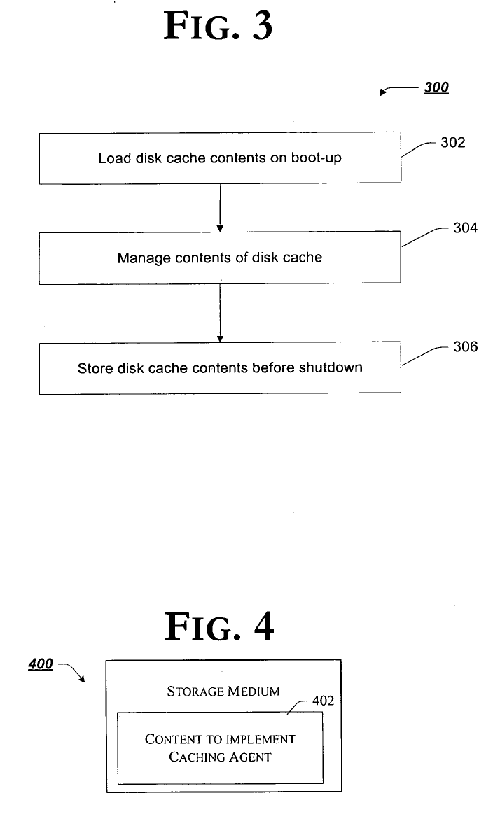

Caching agent 106 may have an architecture as described in greater detail with reference to FIG. 2. Caching agent 106 may also perform one or more methods to keep volatile disk caches warm across reboots, such as the method described in greater detail with reference to FIG. 3. While shown as being a part of memory controller 104, caching agent 106 may well be part of another component, for example expansion controller 110, or may be implemented in software, as part of a driver or operating system, or a combination of hardware and software.

System memory 108 may represent any type of memory device(s) used to store data and instructions that may have been or will be used by processor(s) 102. Typically, though the invention is not limited in this respect, system memory 108 will consist of dynamic random access memory (DRAM). In one embodiment, system memory 108 may consist of Rambus DRAM (RDRAM). In another embodiment, system memory 108 may consist of double data rate synchronous DRAM (DDRSDRAM).

Expansion controller 110 may represent any type of chipset or control logic that interfaces expansion devices with the other components of electronic appliance 100. In one embodiment, expansion controller 110 may be referred to as a south bridge. In one embodiment, expansion controller 110 complies with Peripheral Component Interconnect (PCI) Express Base Specification, Revision 1.0, PCI Special Interest Group, released Apr. 29, 2002.

Storage device 112 may represent any storage device used for the long term storage of data. In one embodiment, storage device 112 may be a hard disk drive comprising a plurality of sectors. In a hard disk drive with a spinning disk, data stored on contiguous sectors and on sectors near the outside of the disk may be accessed quicker. Storage device 112 may contain operating systems and applications, which may comprise various executable, data and library files.

Input/output (I/O) device(s) 114 may represent any type of device, peripheral or component that provides input to or processes output from electronic appliance 100. In one embodiment, though the present invention is not so limited, an I/O device 114 may be a network interface controller.

FIG. 2 is a block diagram of an example caching agent architecture, in accordance with one example embodiment of the invention. As shown, caching agent 106 may include one or more of control logic 202, memory 204, bus interface 206, and caching engine 208 coupled as shown in FIG. 2. In accordance with one aspect of the present invention, to be developed more fully below, caching agent 106 may include a caching engine 208 comprising one or more of load services 210, manage services 212, and/or store services 214. It is to be appreciated that, although depicted as a number of disparate f functional blocks, one or more of elements 202-214 may well be combined into one or more multi-functional blocks. Similarly, caching engine 208 may well be practiced with fewer functional blocks, i.e., with only manage services 212, without deviating from the spirit and scope of the present invention, and may well be implemented in hardware, software, firmware, or any combination thereof In this regard, caching agent 106 in general and caching engine 208 in particular are merely illustrative of one example implementation of one aspect of the present invention. As used herein, caching agent 106 may well be embodied in hardware, software, firmware and/or any combination thereof. For example, caching agent 106 may be implemented completely in software as a disk-driver, a storage controller driver, a RAID controller driver, a file-system driver, or a filter driver anywhere in the storage driver hierarchy. If a driver does this disk caching, it may choose to save the data on shutdowns in a dedicated file. Alternatively, it may carve out a section of the disk-drive, and simply offset OS requests for various sectors around the range if needed. Yet another alternative is to use a dedicated partition on a disk drive.

Caching agent 106 may have the ability to keep volatile disk caches warm across reboots. In one embodiment, caching agent 106 may, responsive to a system boot, load a cache data from a reserved portion of storage device 112 into system memory 108. In another embodiment, caching agent 106 may store a cache data maintained in system memory 108 to storage device 112 just prior to a system shutdown. One skilled in the art would recognize that through this method a cache data in a portion of system memory may emulate a non-volatile memory cache.

As used herein control logic 202 provides the logical interface between caching agent 106 and its host electronic appliance 100. In this regard, control logic 202 may manage one or more aspects of caching agent 106 to provide a communication interface from electronic appliance 100 to software, firmware and the like, e.g., instructions being executed by processor(s) 102.

According to one aspect of the present invention, though the claims are not so limited, control logic 202 may receive event indications such as, e.g., a system boot. Upon receiving such an indication, control logic 202 may selectively invoke the resource(s) of caching engine 208. As part of an example method to keep volatile disk caches warm across reboots, as explained in greater detail with reference to FIG. 3, control logic 202 may selectively invoke load services 210 that may load a disk cache from a reserved portion of storage device 112 into a reserved portion of system memory 108. Control logic 202 also may selectively invoke manage services 212 or store services 214, as explained in greater detail with reference to FIG. 3, to manage the contents of the disk cache in system memory 108 or to store the contents back to storage device 112, respectively. As used herein, control logic 202 is intended to represent any of a wide variety of control logic known in the art and, as such, may well be implemented as a microprocessor, a micro-controller, a field-programmable gate array (FPGA), software, application specific integrated circuit (ASIC), programmable logic device (PLD) and the like. In some implementations, control logic 202 is intended to represent content (e.g., software instructions, etc.), which when executed implements the features of control logic 202 described herein.

Memory 204 is intended to represent any of a wide variety of memory devices and/or systems known in the art. In one embodiment, memory 204 may be a dedicated portion of system memory 108. In another embodiment, memory 204 may be part of a processor, system disk, or network cache. Memory 204 may also be used to store files needed to launch an application, such as executable and dynamic link library files, for example. In this way memory 204 may function as a disk cache that is capable of accelerating system boot and application launch. In one embodiment, memory 204 is a non-volatile memory which stores a flag that is utilized for power failure detection. When the system boots, this flag may be checked, and if it is set, then the cache is not restored from the non-volatile media. If it is not set, however, the system can read the cache data and set the flag in anticipation of a power failure. On a proper shutdown, the system can clear this flag after saving out the cache data.

Bus interface 206 provides a path through which caching agent 106 can communicate with other components of electronic appliance 100, for example storage device 112 or system memory 108. In one embodiment, bus interface 206 may represent a PCI Express interface.

As introduced above, caching engine 208 may be selectively invoked by control logic 202 to load a disk cache from a reserved portion of storage device 112 into a reserved portion of system memory 108, to manage the contents of the disk cache in system memory 108, or to store the contents back to storage device 112. In accordance with the illustrated example implementation of FIG. 2, caching engine 208 is depicted comprising one or more of load services 210, manage services 212 and store services 214. Although depicted as a number of disparate elements, those skilled in the art will appreciate that one or more elements 210-214 of caching engine 208 may well be combined without deviating from the scope and spirit of the present invention.

Load services 210, as introduced above, may provide caching agent 106 with the ability to load a disk cache from a reserved portion of storage device 112 into a reserved portion of system memory 108. In one example embodiment, load services 210 may read a file on a hidden partition of storage device 112 which contains the cache data. Load services 210 may be invoked early in the OS boot process so that OS boot may itself be accelerated in the case where OS data is part of the contiguous cache data file.

As introduced above, manage services 212 may provide caching agent 106 with the ability to manage the contents of the disk cache in system memory 108. In one example embodiment, manage services 212 may update contents of cache data based on the frequency of use of applications. In this way, manage services 212 ensures the data needed to accelerate the launch of the most frequently used applications is stored in the cache data. In another embodiment, manage services 212 may respond to a user indication as to which applications should be accelerated. Manage services 212 may also be able to adjust the size of the disk cache depending on the size of the system memory 108 and user input, to optimize performance.

Store services 214, as introduced above, may provide caching agent 106 with the ability to store the contents back to storage device 112. In one embodiment, store services 214 may utilize a write-back policy to collect changes to the cache data to be written to the hard drive. In another embodiment, store services 214 may utilize a write-through policy to write any changes to cache data in system memory 108 directly through to the cache data file on storage device 112. Store services 214 may also write all the contents of the cache data to the hard drive when an indication associated with a system shutdown is received.

FIG. 3 is a flow chart of an example method for keeping a volatile disk cache warm across reboots, in accordance with one example embodiment of the invention. It will be readily apparent to those of ordinary skill in the art that although the following operations may be described as a sequential process, many of the operations may in fact be performed in parallel or concurrently. In addition, the order of the operations may be re-arranged without departing from the spirit of embodiments of the invention.

According to but one example implementation, the method of FIG. 3 begins with control logic 202 selectively invoking load services 210 to load (302) disk cache contents on boot-up. In one example embodiment, load services 210 copies a file from a contiguous portion of storage device 112, perhaps a hidden partition, to a dedicated portion of system memory 108. In one embodiment, a flag stored in a non-volatile memory is checked to before loading the cache to ensure the cache data was saved properly before shutdown.

Control logic 202 may then selectively invoke manage services 212 to manage (304) contents of the disk cache while electronic appliance 100 is operating. In one example embodiment, manage services 212 may alter the contents of the disk cache over time based on system activity so as to optimize performance. In another example embodiment, manage services 212 may accommodate changes to the disk cache offered by a user.

Next, store services 214 may store (306) disk cache contents before shutdown. In one embodiment, store services 214 ensures that any changes to the cache data in system memory 108 are mirrored to the file on storage device 112, through a write-through cache policy. In another embodiment, store services 214 may write the entire contents of the disk cache in system memory 108 to storage device 112 just prior to a system shutdown. In one embodiment, store services 214 clears a flag in non-volatile memory after saving the cache data to indicate the status of the cache data on a subsequent boot.

FIG. 4 illustrates a block diagram of an example storage medium comprising content which, when accessed, causes an electronic appliance to implement one or more aspects of the caching agent 106 and/or associated method 300. In this regard, storage medium 400 includes content 402 (e.g., instructions, data, or any combination thereof) which, when executed, causes the appliance to implement one or more aspects of caching agent 106, described above.

The machine-readable (storage) medium 400 may include, but is not limited to, floppy diskettes, optical disks, CD-ROMs, disk drives, and magneto-optical disks, ROMs, RAMs, EPROMs, EEPROMs, magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem, radio or network connection).

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

Embodiments of the present invention may be used in a variety of applications. Although the present invention is not limited in this respect, the invention disclosed herein may be used in microcontrollers, general-purpose microprocessors, Digital Signal Processors (DSPs), Reduced Instruction-Set Computing (RISC), Complex Instruction-Set Computing (CISC), disk drives, computers, among other electronic components. However, it should be understood that the scope of the present invention is not limited to these examples.

Many of the methods are described in their most basic form but operations can be added to or deleted from any of the methods and information can be added or subtracted from any of the described messages without departing from the basic scope of the present invention. Any number of variations of the inventive concept is anticipated within the scope and spirit of the present invention. In this regard, the particular illustrated example embodiments are not provided to limit the invention but merely to illustrate it. Thus, the scope of the present invention is not to be determined by the specific examples provided above but only by the plain language of the following claims.
What is claimed is:

1. A method comprising:
responsive to a system boot, loading a cache data from a reserved portion of a non-volatile storage device into a volatile memory.

2. The method of claim 1, wherein loading the cache data from the non-volatile storage device comprises loading the cache data from contiguous sectors of a hard drive.

3. The method of claim 2, wherein loading the cache data into a memory comprises loading the cache into a reserved portion of a system memory.

4. The method of claim 3, further comprising:
storing the cache data back to the hard drive prior to a shutdown.

5. The method of claim 3, further comprising:
updating the cache data stored on the hard drive using a write-through policy.

6. The method of claim 3, wherein the cache data comprises files needed to launch frequently used applications.

7. An electronic appliance, comprising:
a processor;
a memory coupled with the processor;
a storage device coupled with the memory; and
a caching engine coupled with the memory, the caching engine to, responsive to a system boot, load a cache data from a contiguous portion of the storage device into a reserved portion of the memory.

8. The electronic appliance of claim 7, wherein the storage device comprises a hard drive.

9. The electronic appliance of claim 8, further comprising:
the caching engine to store the cache data back to the hard drive substantially contemporaneous to a shutdown.

10. The electronic appliance of claim 8, further comprising:
the caching engine to update the cache data stored on the hard drive using a write-through policy.

11. The electronic appliance of claim 8, further comprising:
the caching engine to update the cache data stored on the hard drive using a write-back policy.

12. The electronic appliance of claim 8, wherein the cache data comprises files needed to accelerate performance of the electronic appliance.

13. A storage medium comprising content which, when executed by an accessing machine, causes the accessing machine to write disk cache contents maintained in a portion of a system memory to a dedicated portion of a mass storage device.

14. The storage medium of claim 13, further comprising content which, when executed by the accessing machine, causes the accessing machine to store the disk cache contents to the mass storage device prior to a system shutdown and to clear a power failure detection flag.

15. The storage medium of claim 14, further comprising content which, when executed by the accessing machine, causes the accessing machine to load the disk cache contents from the mass storage device during a system boot.

16. The storage medium of claim 14, further comprising content which, when executed by the accessing machine, causes the accessing machine to store the disk cache to contiguous sectors of a hard drive.

17. The storage medium of claim 16, further comprising content which, when executed by the accessing machine, causes the accessing machine to write-back disk cache data to the hard drive.

18. A method, comprising:
maintaining a disk cache in a portion of a system memory; and
writing the disk cache contents to a dedicated portion of a mass storage device.

19. The method of claim 18, further comprising storing substantially all the disk cache contents to the mass storage device prior to a system shutdown.

20. The method of claim 19, further comprising loading the disk cache contents from the mass storage device during a system boot if a power failure detection flag is not set.

21. The method of claim 19, further comprising storing the disk cache to contiguous, outer sectors of a hard drive.

22. The method of claim 21, further comprising writing-back disk cache data to the hard drive.
